(19) United States
(12) Patent Application Publication
(10) Pub. No.: US 2023/0296823 A1
(43) Pub. Date: Sep. 21, 2023

(54) LIGHT INCOUPLING TAPE, RELATED METHOD AND USES

(71) Applicant: NITTO DENKO CORPORATION, Osaka (JP)

(72) Inventors: Kozo NAKAMURA, Osaka (JP); Minoru MIYATAKE, Osaka (JP); Yufeng WENG, Osaka (JP); Kari RINKO, Helsinki (FI); Shingo MATSUMOTO, Tokyo (JP)

(73) Assignee: NITTO DENKO CORPORATION, Osaka (JP)

(21) Appl. No.: 18/019,298

(22) PCT Filed: Aug. 4, 2021
(86) PCT No.: PCT/JP2021/028954

§ 371 Date: Feb. 2, 2023

(30) Foreign Application Priority Data
Aug. 6, 2020 (JP) 2020-134107

(51) Int. Cl. F21V 8/00

(52) U.S. Cl. CPC G02B 6/0055; G02B 6/0016; G02B 6/002; G02B 6/0073; G02B 6/0068; G02B 6/0026; G02B 6/0065; G02B 6/0088

(57) ABSTRACT

An optical incoupling tape (50) attachable on a lightguide (20) is provided, comprising a substrate (50A) and at least one pattern (51) formed with a number of periodic pattern features (52) embedded in the substrate (50A) and configured as optically functional cavities (52) filled with a material having a refractive index different from the refractive index of the material of the substrate (50A) surrounding the cavity (52). The pattern (51) is configured to incouple light incident thereto and to adjust direction of the incoupled light such, that the incoupled light acquires a propagation path through a lightguide medium (20) via a series of total internal reflections. A method for manufacturing the tape (50), related uses and an optical apparatus comprising the tape (50) integrated with a light emitter device (22) are further provided.

### TECHNICAL FIELD

Generally the present invention pertains to provision of optical structures for waveguides and methods for producing the same. In particular, the invention concerns a flexible solution based on integrated cavity-optics adapted to incouple emitted light into an optical waveguide and to control light propagation through said waveguide, related methods and uses.

### BACKGROUND ART

Optical waveguide or lightguide technology has been widely used in a variety of state-of-the-art applications. Proper selection of a light distribution system often predetermines illumination performance of the optical waveguide in lighting- and display applications. A typical lightguide (LG) system contains components for edge incoupling light ray emitted by one or more emitter, components for light distribution through the lightguide element and component(s) or area(s) for light extraction (outcoupling). The incoupling structures receive light and adjust its direction to guide light rays into the light distribution area. Advanced lightguides include optical patterns that control light edge incoupling efficiency upon entering the lightguide.

In order to control angular distribution of emitted light and to achieve a desired optical performance, conventional lightguide solutions designed for illumination applications still utilize a number of separate optical films for light outcoupling, such as brightness enhancement films (BEFs), for example. Known lightguide solutions implemented without BEFs typically employ microlens- and V-groove shaped optical patterns. By using such solutions, it is impossible to achieved fully controlled illumination distribution in a desired manner. Light incoupling is typically performed at the edge of the lightguide without any advanced optic solution. In some special cases, such augmented and virtual reality headsets, planar surface incoupling is utilized based on surface relief gratings, for example, which are included in the lightguide element.

Angulo Barrios and Canalejas-Tejero [1] disclose a light coupling solution in a flexible Scotch tape waveguide attainable via an integrated metal diffraction grating. Incoupling and outcoupling gratings are embedded inside two layers of the Scotch tape; whereby the Scotch tape is rendered with an optical waveguide functionality. The grating is implemented as a metal (Al) nanohole array (NHA) grating.

US 2015/192742 A1 (Tarsa & Durkee) discloses a light extraction film laminated on the surface of a lightguide. Light extraction function is based on Total Internal Reflection (TIR). The extraction film forms air pockets between the film and the lightguide, upon being secured, by lamination, for example, to the lightguide.

US 2018/031840 A1 (Hofmann et al) discloses an optical element with an embedded optical grating to extract light from a lightguide. Surface of the grating is coated with an optically effective layer by using known methods, such as chemical vapour deposition (CVD) or physical vapour deposition (PVD). Moreover, the recesses present in the grating are filled up with an optical cement or optical adhesive material.

U.S. Pat. No. 10,598,938 B1 (Huang & Lee) discloses an angular selective slanted grating coupler for controlling angles at which the light is coupled out from the lightguide or coupled in the lightguide. Selectivity can be achieved by modulating refractive index between gratings or modulating a duty cycle of the gratings in different regions.

Kress [2] discloses in- and outcouplers for optical waveguides, said couplers comprising different types of gratings configured for a transmissive function and/or a reflective function. The couplers can sandwiched/buried in a lightguide or provided as surface relief solutions.

Moon et al [3] discloses an outcoupler using microstructured hollow (air) cavity gratings to improve light extraction in LED devices. Hollow cavities are fabricated in semiconductor materials with typical methods. Apart from LEDs, other applications (e.g. in lightguides) of the outcoupler solution are not provided.

Designing and optimizing lightguide-based illumination-related solutions is confronted with certain challenges associated with non-uniform light distribution inside the lightguide, insufficient in- and outcoupling, light trapping and/or extraction efficiency. The above described solutions are also limited in a sense of being incapable of providing integrated air-cavity optics-based flexible solutions with satisfactory versatility and adaptability for a variety of target applications, such as large-sized window illumination with planar surface light incoupling.

In this regard, an update in the field of optical structures for non-fiber lightguides aiming at enhancing luminance uniformity and improving optical efficiency of said lightguides, is still desired, in view of addressing challenges associated with manufacturing and assembling of presently existing solutions.

### SUMMARY OF INVENTION

An objective of the present invention is to at least alleviate each of the problems arising from the limitations and disadvantages of the related art. The objective is achieved by various embodiments of an optical incoupling tape, according what is defined in the independent claim 1.

In an embodiment, the optical incoupling tape for a lightguide is provided comprising a substrate and at least one pattern formed with a number of periodic pattern features embedded in a substrate material and configured as optically functional embedded cavities filled with a material having a refractive index different from the refractive index of the material of the substrate surrounding the cavity. In said tape, the pattern is configured to incouple light incident thereto and to adjust direction of the incoupled light such, that the incoupled light acquires a propagation path through a lightguide medium via a series of total internal reflections. The tape is attachable onto at least one planar surface of the lightguide, whereby an optical contact for light transmission between the tape and a lightguide medium is formed.

In embodiment, the optical incoupling tape is configured such, that in said tape the incoupled light is redirected at an interface between each said cavity and the material of the substrate surrounding the cavity to acquire the propagation path through the lightguide medium, whereupon an angle of incidence at an interface between the lightguide medium and an ambient, and, optionally, an angle of incidence at the interface between each cavity and the material of the substrate surrounding the cavity is/are larger than or equal to a critical angle of total internal reflection.

In embodiment, in said tape the at least one pattern is configured to perform an optical function related to incoupling- and adjusting direction of light received thereto, wherein said optical function is selected from a group consisting of: a reflection function, an absorption function, a transmittal function, a collimation function, a refraction function, a diffraction function, a polarization function, and any combination thereof.

In embodiment, in said tape the pattern is rendered optically functional by providing a cavity or a group of cavities in the pattern with a number of parameters, wherein the number of parameters comprises any combination of parameters selected from the group consisting of: dimensions, shape, cross-sectional profile, orientation, periodicity, and fill factor.

In embodiment, each individual cavity in the pattern has a number of optically functional surfaces. In embodiments, the optically functional surface or surfaces is/are established by any surface or surfaces formed at the interface between each cavity and the material of the substrate surrounding the cavity. In embodiments, the optically functional surface or surfaces in each individual cavity in the pattern is/are established with any one of a low refractive index reflector, a polarizer, a diffuser, an absorber, or any combination thereof.

In embodiment, the optical incoupling tape further comprises a wavelength conversion layer.

In different embodiments, in said tape, the cavities are configured and arranged in the pattern such, as to form a substantially variable periodic pattern or to form a substantially constant periodic pattern.

In embodiment, in the pattern the cavities are established with discrete or at least partly continuous pattern features.

In embodiment, the optical incoupling tape comprises a number of patterns arranged in periodic segments, each segment having a predefined area and a length of a period.

In embodiment, the patterns in said tape are configured variable by a number of cavity-related parameters, wherein the number of cavity-related parameters comprises an individual parameter or any combination of parameters selected from the group consisting of: dimensions, shape, cross-sectional profile, orientation, position, periodicity, and fill factor.

In embodiment, the cavities are established with two-dimensional- or three-dimensional pattern features having cross-sectional profiles selected from the group consisting of: linear, rectangular, triangular, blazed, slanted, trapezoid, curved, wave-shaped and sinusoidal profiles.

In embodiment, the cavities are filled with a gaseous material, such as air.

In embodiments, the optical incoupling tape is configured attachable onto a planar surface or planar surfaces of the lightguide. The tape can be attached by adhesion.

In embodiments, the pattern or patterns comprise(s) cavities formed in the substrate provided as an essentially flat, planar substrate layer. Said essentially flat, planar substrate layer, in which the cavities are formed, can be made of substantially optically transparent material. In embodiments, the pattern or patterns comprise(s) fully embedded cavities formed at an interface with an additional flat, planar substrate layer, provided as an optically transparent layer, a reflector layer, and/or a coloured layer.

In embodiment, the optical incoupling tape comprises a number of embedded patterns arranged in a stacked configuration.

In embodiment, the optical incoupling tape comprises a wedge structure.

In another aspect, a method for manufacturing an optical incoupling tape comprising at least one pattern formed with a number of periodic cavity features embedded in a substrate material is provided, in accordance to what is defined in the independent claim 22.

In embodiment, the method comprises:
manufacturing a patterned master tool for said at least one pattern by a fabrication method selected from any one of: lithographic, three-dimensional printing, micro-machining, laser engraving, or any combination thereof;
transferring the pattern onto the substrate to generate a patterned substrate; and
generating an embedded cavity pattern or patterns by applying onto said patterned substrate an additional substrate layer or a cover layer,
wherein the embedded cavity pattern(s) comprise(s) cavities configured as optically functional cavities filled with a material having a refractive index different from the refractive index of the material of the substrate surrounding the cavity, and wherein said embedded cavity pattern is configured to incouple light incident thereto and to adjust direction of the incoupled light such, that the incoupled light acquires a propagation path through a lightguide medium via a series of total internal reflections.

In embodiment, the additional substrate layer is applied onto the patterned substrate layer by a lamination method selected from any one of: a roll-to-roll lamination, a roll-to-sheet lamination or a sheet-to-sheet lamination.

In embodiment, the method further comprises replication of a fabricated pattern, wherein pattern replication method is selected from any one of imprinting, extrusion replication or three-dimensional printing.

In another aspect, a lightguide is provided, in accordance to what is defined in the independent claim 25. Said lightguide comprises an optically transparent medium configured to establish a path for light propagation through the lightguide and an optical incoupling tape, according to some previous aspect, said tape being attached onto at least one planar surface of said lightguide.

In embodiment, the lightguide comprises the optical incoupling tape attached thereto by adhesion.

In another aspect, use of a lightguide according to the previous aspect is provided in illumination and/or indication, in accordance to what is defined in the independent claim 27.

In further aspect, a roll of an optical incoupling tape is provided, in accordance to what is defined in the independent claim 28, wherein the optical incoupling tape is implemented according to some previous aspect.

In still further aspect, an optical unit is provided, in accordance to what is defined in the independent claim 29. Said optical unit comprises an optical incoupling tape, according to some previous aspect, with an adhesion layer for a lightguide attachment and at least one emitter device.

In embodiment, the at least one emitter device is selected from a group consisting of: a Light Emitting Diode (LED), an Organic Light Emitting Diode (OLED), a laser diode, a LED bar, an OLED strip, a microchip LED strip, and a cold cathode tube.

In embodiment, the optical unit comprises at least one light emitter device configured for emitting monochromic light, and the optical incoupling tape that comprises the wavelength conversion layer.

The utility of the present invention arises from a variety of reasons depending on each particular embodiment thereof. At first, the invention pertains to a novel optical tape solution configured to incouple photons of optical radiation (light) emitted by at least one emitter device and to adjust direction on incoupled light rays to mediate light propagation through the lightguide medium. The optical tape according to the present invention is advantageously designed for a planar, non-fiber lightguide.

One of the primary benefits offered by the optical incoupling tape according to the present invention is incoupling of light into planar lightguide surface(s). Hence, the tape enables incoupling of light rays arriving onto the planar lightguide surface from any direction, and efficient capturing of the light rays inside said planar lightguide. At the same time, the tape adjusts direction of incoupled light such, that light rays stay inside the lightguide (light leakage is prevented). In particular, the tape disclosed hereby enables incoupling of light into large-sized (planar) windowpanes; the latter being impossible with presently known solutions based on incoupling from the edge of the window.

Known incoupling solutions are typically fixed, solid structures provided inside the lightguide that prevents them from being efficiently used in preinstalled window surfaces, for example, for the above mentioned reasons. In terms of manufacturing, such fixed incoupling structures are not suitable for high-volume production, such as by etching on a window glass installed in the building, for example. Additionally, mentioned fixed solutions do not allow for combining different optical functionalities in the same incoupling structure.

The incoupling tape presented hereby provides additional flexibility with regard to positioning of a light source. Light emitter can be integrated inside the tape or installed on the tape. Alternatively, the emitter can be placed at a distance from the tape to avoid subjecting the optical incoupling tape and lightguide to heat energy (e.g. in case of a laser light source).

The tape, which is configured attachable to at least on one surface of said optical element by an adhesive layer, for example, controls incoupling of emitted light and its further propagation inside the optical medium (viz., the lightguide medium). The incident light incoupled on the tape pattern(s) is deflected from the original propagation path by a certain angle by means of (air)-cavity optics embedded inside of the tape. Totally integrated and embedded cavity optics is based on two- or three-dimensional pattern matrix, which may comprise a single-profile or multiple profiles, and by virtue of profile configuration, to attain a desired light management.

The tape is configured to couple incident light from an emitter device disposed outside the tape. Light incident at a wide range of angles of incidence can be efficiently (in)coupled. The tape thus allows for at least incoupling- and redirecting the incoupled light into the optical element (lightguide).

The tape is extremely easy to install and it provides flexibility for removal, changing and installing again to wherever desired. The optical structure(s) in the tape is/are protected from external conditions and thus reliable. Improved incoupling efficiency and enhanced light distribution control also improve the characteristics of outcoupled light.

Optical incoupling tape, according to the present disclosure, is easy and reliable to utilize because of its embedded cavity optics, which, due to its internal nature, cannot be destroyed or defected by normal handling procedures, including assembling, cleaning, etc. In a ready-to-use state the tape does not have any surface relief patterns formed on its surfaces. Since the tape has entirely flat and planar external surfaces, it possible to touch and clean the tape without modifying or losing its optical performance. The tape can be easily attached, by means of an adhesive surface, for example, onto the related optical element, either manually or in an automated manner.

Flexible tape solution can be configured with any desired combination of size-related parameters (length×width×thickness/height). The tape is easy to apply on any surface of the lightguide, e.g. any side- and/or edge(s).

In some preferred embodiments, the solution provided hereby is advantageously realized as integrated (internal) cavity optics. In conventional solutions that involve optical cavities light is often transmitted (penetrated) into said cavities, whereby undesired refraction is caused and light distribution control is not achievable. On the contrary, in the solution presented hereby extracted light distribution (in terms of refraction angle and directions, accordingly) can be controlled with high precision by TIR functionality of the associated optically functional feature pattern.

Optical design of the light incoupling tape can be constant, with the optical pattern solutions being based on similar and continuous repeating patterns, such as comprising periodical features. Alternatively, the tape may comprise continuously variable patterns or segmental patterns, wherein each local pattern design is predetermined for a characteristic angle of incidence or a range of incidence angles. Naturally, the solution is designed and optimized for certain lightguide thicknesses and other specific parameters.

One of the principal purposes the light incoupling tape according to the present invention aims at is improving functionality of the optical element, such as lightguide, wherein the tape is adhered onto its surface. The incoupling tape can be used alone or in combination with an optical harmonizer (deflection) tape. Provision of incoupling tape and light deflecting tape on the same lightguide elements is beneficial for optimizing optical performance.

The terms “optical radiation” and “light” are largely utilized as synonyms unless explicitly stated otherwise and refer to electromagnetic radiation within a certain portion of the electromagnetic spectrum covering ultraviolet (UV) radiation, visible light, and infrared radiation. In some instances, visible light is preferred.

In its broadest sense, the term “lightguide”, “waveguide” or “optical waveguide”) refers, in the present disclosure, to a device or a structure configured to transmit light therealong (e.g. from a light source to a light extraction surface). The definition involves any type of the lightguide, including, but not limited to a light pipe type component, a lightguide plate, a lightguide panel, and the like.

The expression “a number of” refers herein to any positive integer starting from one (1), e.g. to one, two, or three; whereas the expression “a plurality of” refers herein to any positive integer starting from two (2), e.g. to two, three, or four.

The terms “first” and “second” are not intended to denote any order, quantity, or importance, but rather are used to merely distinguish one element from another.

### BRIEF DESCRIPTION OF DRAWINGS

Different embodiments of the present invention will become apparent by consideration of the detailed description and accompanying drawings, wherein:

FIGS. 1A and 1B are cross-sectional views of a lightguide with an optical incoupling tape 50, according to the embodiments, attached thereto.

FIG. 1C illustrates an optical apparatus (unit) comprising the incoupling tape 50.

FIG. 2 shows various configurations for utilization of the incoupling tape 50 on the lightguide (cross-section view).

FIG. 3 is a cross-sectional view of the incoupling tape 50, according to the embodiments.

FIG. 4 illustrates embedded cavity patterns for the incoupling tape 50 with different fill factor, according to an embodiment.

FIG. 5 is a graph illustrating an amount of incoupled light relative to light source collimation and position of the patterns with different fill factor, as shown on FIG. 4.

FIG. 6 describes an arrangement similar to that illustrated on FIG. 4, but having cavity features in the embedded pattern comprising a low refractive index material.

FIG. 7 is a graph illustrating an amount of incoupled light relative to light source collimation and position of the pattern, as shown on FIG. 6.

FIG. 8 illustrates embedded cavity patterns for the incoupling tape 50 with different fill factor, according to another embodiment.

FIG. 9 is a graph illustrating an amount of incoupled light relative to light source collimation and position of the patterns with different fill factor, as shown on FIG. 8.

FIG. 10 is a cross-sectional view of the incoupling tape 50 with the embedded cavity pattern, according to the embodiments.

FIGS. 11A and 11B illustrate the incoupling tape 50 attached on the lightguide element with a collimated light source.

FIG. 12 shows cross-sectional views of the tape, according to some embodiments.

FIGS. 13A and 13B are illustrative of utilization of the incoupling tape 50 and an optical unit 150 utilizing the same in combination with a light harmonizer tape 10.

### DESCRIPTION OF EMBODIMENTS

Detailed embodiments of the present invention are disclosed herein with the reference to accompanying drawings. The same reference characters are used throughout the drawings to refer to same members. Following citations are used for the members:
50—an optical incoupling tape with a substrate 50A;
51—a pattern;
52—optical (pattern) features/cavities with optically functional surfaces 521, 522;
53—contact areas;
54—a shaped exterior surface of the incoupling element;
In the tape 50:
511—an optically functional layer;
511A, 511B—a patterned substrate layer and an additional substrate layer, accordingly;
512, 513—additional functional layers of the tape 50;
515—an internal functional component (layer);
10—a harmonizer tape (control over distribution of light propagation through the lightguide);
20—an optical waveguide;
21—an outcoupling pattern;
22—a support for an emitter device;
30—an emitter device (a light source);
31—rays of emitted optical radiation;
32—rays of incoupled and/or redirected optical radiation;
33—rays of extracted electromagnetic optical;
150—an optical apparatus (unit).

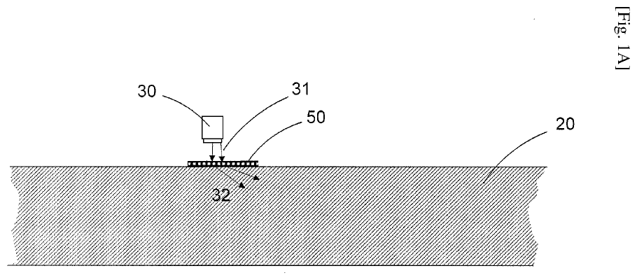

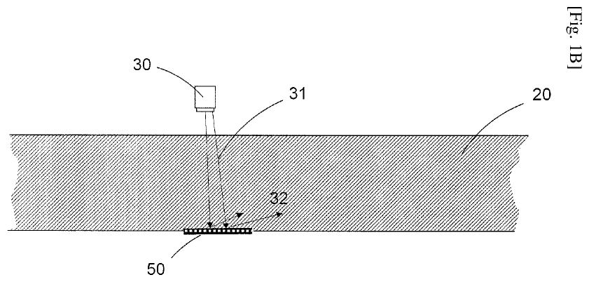

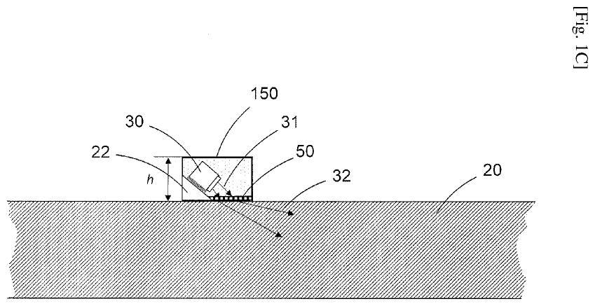

FIGS. 1A and 1B illustrate, at 50, some basic embodiments of an optical incoupling tape. FIGS. 1A and 1B are cross-sectional views of an optical element 20, such as an optical waveguide structure, with the optical incoupling tape 50 (hereafter, the “tape”) attached on at least one surface of said waveguide. The optical waveguide, also referred to as lightguide, is a structure configured to deliver optical radiation (light) emitted by at least one appropriate emitter device 30 towards a particular area that requires illumination. The lightguide is a planar (non-fiber) lightguide with essentially planar surface(s). In a basic lightguide layout (e.g. shown on any one of FIGS. 1A and 1B) one may distinguish a top surface, a bottom surface and two or more edge surfaces. The top- and bottom surface form horizontal faces of the lightguide, whereas the edges extend essentially vertically, optionally inclined at a predetermined angle, between said top- and bottom surfaces along a path that surrounds said waveguide element when viewed as a two-dimension shape (viz. along a perimeter). Longitudinal plane of said planar lightguide lies along its horizontal surface(s).

The lightguide comprises a light-transmitting carrier medium formed from optical polymer or glass. In exemplary embodiments, the lightguide (carrier) medium is polymethyl methacrylate (PMMA). For clarity, reference numeral 20 is used to indicate both the lightguide as an entity and the carrier medium said lightguide is made from.

The tape 50 can be attached on one side- or on both sides (top, bottom) of the planar lightguide. It is reasonable to install the tape 50 on the same side of the lightguide that bears other optical structures, such as a light outcoupling/extracting layer, for example. Especially in window illumination it is beneficial to assemble all optical structures on the window surface facing the interior of a building or a space between the layered windows, due to environment factors.

FIGS. 1A and 1B shows lightguide solutions having the tape 10 attached directly onto its surface (top surface, FIG. 1A; and bottom-/back surface, FIG. 1B). In configuration of FIG. 1A the emitter device 30 is disposed directly above the tape 50 arranged on the surface of the lightguide 20. In such configuration optical radiation rays 31 are incident directly on the tape 50. The emitter 30 and the tape 50 are positioned at the same side relative to the lightguide 20.

In configuration of FIG. 1B the emitter 30 is disposed essentially above the tape 50, but has a lightguide material 30 in between. The tape 50 is thus attached to the opposite side of the lightguide relative to position of the emitter 30 (with reference to layout of FIG. 1B, the tape is provided at a bottom side of the lightguide). Hence, optical radiation rays 31 arrive on the tape through the lightguide medium 20. The emitter can be positioned above the lightguide material, as shown on FIG. 1B such that air-lightguide material interface is created or the emitter can be brought into contact with the lightguide material.

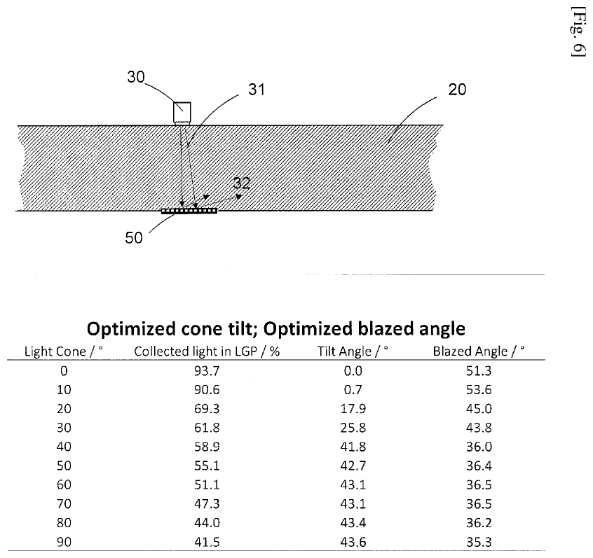

The tape 50 can be attached to both the top- and bottom-/back surfaces of the lightguide. In such an event the emitter(s) 30 can be placed against any one of the top- and back surfaces or both (see FIG. 6). The tape 50 attached at both surfaces can be rendered with same/similar or different functions.

FIG. 1C illustrates utilization of the optical incoupling tape 50 in an optical apparatus or unit 150. The unit 150 comprises the tape 50 and at least one emitter 30 configured to emit optical radiation. The emitter 30 is fully integrated into the optical unit 150. In some configurations the emitter 30 is provided with a collimation device, such as a collimation lens. The tape and the emitter are advantageously provided in a housing. The housing is optionally open at a side of placement of the tape on the lightguide surface. The unit 150 has height (h) of about 0.5-10 mm and it can incorporate the tape 50 of any appropriate length/width. The tape 50 is advantageously provided with means for a lightguide attachment, such as an adhesion layer.

The emitter 30 may be provided on a support 22. The support 22 may inclined (FIG. 1C) to direct emitted (and collimated) light on the tape at a predetermined angle. Said inclination angle (the angle defining a slope of the support 22) may be modified depending on design specification and general implementation of the optical lightguide system.

The emitter(s) 30 is/are arranged essentially above or against the tape 50 attached to the lightguide surface such that light rays fall onto the tape either at essentially straight angle (parallel to the lightguide surface normal or the tape surface normal; FIGS. 1A, 1B) or at a predetermined angle relative to the surface normal. (FIG. 1C) By surface normal we refer to a line or a vector perpendicular to the surface of an object (hereby, the lightguide and the tape attached thereto, accordingly). A predetermined angle is selected within a range between 10-90 degrees relative to the surface normal (includes e.g. 15, 20, 25, 30, 35, 40, 45, 50, 55, 60, 65, 70, 75, 80, 85 degrees and any intermediate value). The tape 50 is thus configured for incoupling essentially top-side light.

The tape 50 and the unit 150 can be utilized with any lightguide having essentially planar surface(s), independent on its thickness.

It is preferred that the tape 50 has uniform exterior surfaces (the surface facing the lightguide and the surface opposite thereto), i.e. without any surface relief patterns or related structures formed thereon. Still preferably, these surfaces are configured entirely flat and planar.

In view of the utilized technology, implementation of the tape 50 comprising relief patterns (open cavity patterns) is not excluded. optical out-coupling pattern

In terms of size-related parameters (length, width, height/thickness), the tape 50 can be configured as required for achieving optimal performance efficiency. Attaching the tape onto the lightguide is enabled or facilitated by adhesion, for example.

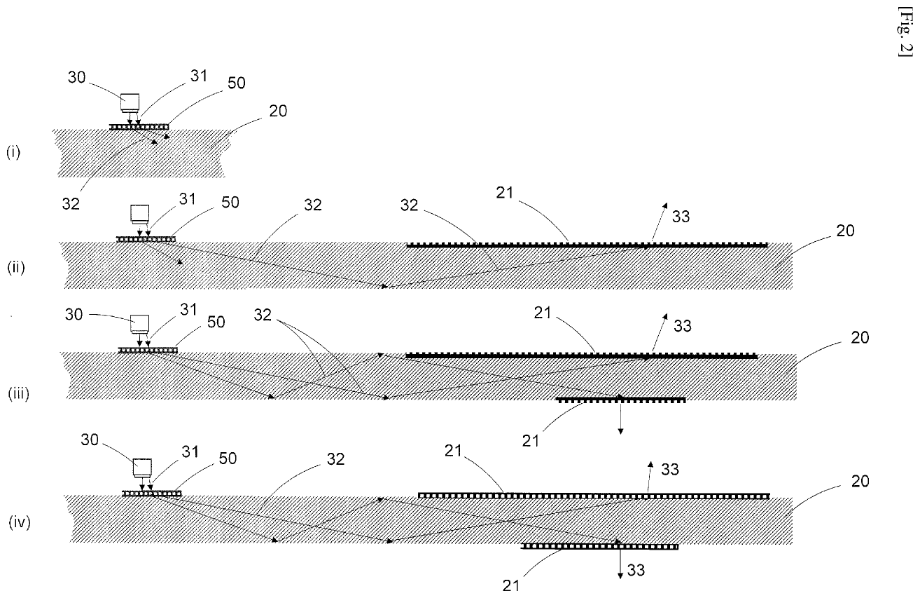

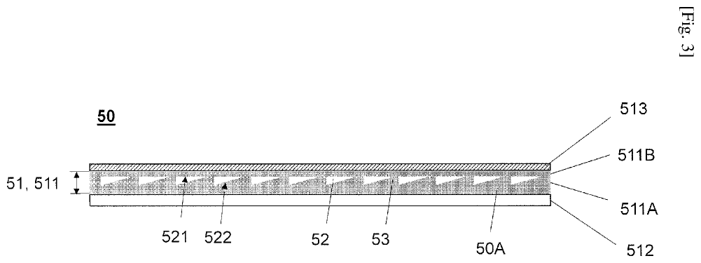

FIG. 2 shows, at (i)-(iv), various layouts for the optical incoupling tape 50 on the lightguide 20. Layout (i) is essentially the same as the one shown on FIG. 1A. Layouts (ii) and (iii) show provision of the tape 50 on a planar lightguide medium with a conventional single-sided light out-coupling pattern 21 (ii) and with a conventional dual-sided light out-coupling pattern 21 (iii). Layout (iv) shows provision of the tape 50 on a planar lightguide medium having a single-sided- or a dual-sided light outcoupling patterns 21 configured with embedded cavity optics (while a single-sided configuration is not particularly shown, it can be easily conceived based on FIG. 3, iv).

In all options (i)-(iv) the tape 50 can be provided at one side of the planar lightguide medium or at two sides. Alternatively or additionally the unit 150 can be utilized.

The tape 50 is configured to receive and to incouple rays of optical radiation 31 (light) emitted from the emitter or emitters 30. The tape is further configured to adjust direction of incoupled light and to mediate light propagation (rays 32) through the lightguide medium towards the out-coupling area(s) 21. Extracted/out-coupled light is indicated by reference numeral 33. An optical out-coupling pattern can be integrated into the lightguide medium by replication, for example, or provided in the form of a coating or a tape applied on the surface of the lightguide.

The tape 50 attached onto at least one surface of the lightguide 20 forms an optical connection or an optical contact for light transmission (propagation) into and through the lightguide medium. Upon attaching the incoupling tape on the lightguide, an optical contact is established at an interface between the lightguide medium 20 and a tape medium (substrate 50A). Optical contact may be established via mechanical connection or via bonding, by optically clear adhesive, for example.

FIG. 3 is a cross-sectional view of the optical incoupling tape 50, according to some embodiments. The incoupling tape 50 comprises a substrate 50A and at least one pattern 51 formed with a number of pattern features 52 embedded in the substrate. Arrangement of pattern features 52 in the substrate material is preferably periodic; however, provision of the pattern 51 as a non-periodic structure is not excluded. The features 52 are configured as optically functional cavities (viz. internal, embedded or integrated cavity optics). The latter are further referred to as “cavities” or “cavity profiles”. The substrate material 50A with the embedded pattern 51/embedded cavities 52 forms an optically functional layer 511.

The internal cavities 52 are filled with a material having a refractive index different from the refractive index of the material of the substrate surrounding the cavity.

In some configurations, the cavities 52 are filled with a low refractive index material.

Additionally or alternatively, the cavities may be provided with a low refractive index coating. In some configurations, the cavities 52 are filled with air to establish an embedded air-cavity optics solution. Overall, the filling material for said cavities can be established with any one of: a gaseous medium, including air or other gas, fluid, liquid, gel, and solid.

The optically functional layer 511 with embedded pattern 51 is formed from at least two (sub)layers 511A, 511B. A first substrate layer 511A comprises an essentially flat, planar surface with at least one cavity pattern formed therein (hereafter, a patterned layer). The patterned layer 511A may be provided as a flat, planar layer of substrate material having uniform thickness, in which at least one cavity pattern has been formed. To establish internal cavities and to form an embedded optical pattern, the first substrate layer with a patterned surface is brought against an entirely flat, planar surface of a second substrate component 511B such, that at least one embedded cavity pattern 51 with embedded cavities 52 alternating with flat junction point or areas 53 is formed at an interface between the patterned substrate surface of the first layer 511A and the entirely flat, planar surface of the second substrate layer 511B.

In practice, the layer 511A is an essentially flat, planar substrate layer with a pattern or patterns comprise(s) cavities (hereafter, a patterned layer). To establish internal cavities and to form an embedded optical pattern, an additional substrate layer 511B, preferably provided as an entirely flat, planar layer, is arranged against the (patterned) layer 511A such, that the internal (viz. embedded or integrated) feature pattern 51 is established at an interface between the patterned layer 511A and the planar layer 511B. The boundary between the substrate layers 511A, 511B is not indicated to emphasize an essentially “one-piece” nature of the optically functional layer 511 with the embedded pattern 51.

In some configurations, the second substrate layer 511B is provided as an entirely flat, planar layer of substrate material having uniform thickness.

The additional substrate layer 511B can be provided as an optically transparent layer and/or as a coloured layer. The layers 511A, 511B can be made from the same substrate material and/or the substrate material with essentially same refractive index. Alternatively, these layers can be made from different materials, the difference being established in terms of at least refractive index, transparency, color and associated optical properties (transmittance, reflectivity, etc.). For example, the entire optically function layer 511 (with both layers 511A, 511B) can be made of a substantially optically transparent substrate material, such as transparent polymer or elastomer, UV resin and the like. Alternatively, the layers 511A, 511B can be made of different materials, having different refractive indices, accordingly.

In some embodiments, the tape 50 is formed with the functional layer 511 alone. Such tape consists of the layer 511 having the pattern(s) 11/(air)-cavity profiles 12 totally embedded inside the substrate material (with no prominent pattern features established on external surfaces).

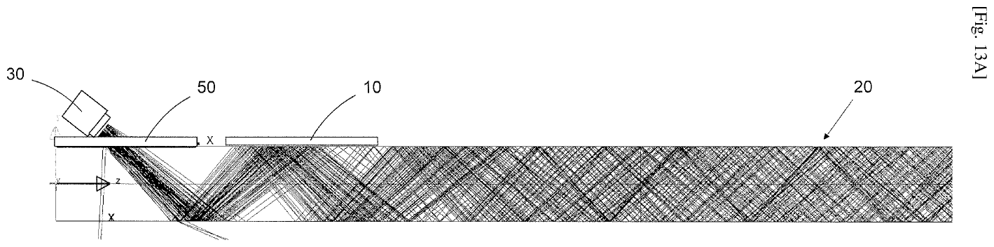

The functional layer 511 and the tape 50 can be implemented with a number of embedded patterns arranged in a stacked configuration. Configuration includes joining two or more layers 511 together to form a multilayer solution in a single tape (see FIG. 12, B). Additionally or alternatively, two or more tapes 50 can be applied on the top of each other to form a multilayer tape configuration.

In some instances, the optically functional layer 511 thus comprises two or more patterned layers 511A stacked on the top of each other, optionally alternating with flat substrate layer(s) 511B. Flat, planar interface between the patterned layers may thus be established by virtue of the patterned layers 511A. The topmost patterned layer may thus be provided with the entirely flat substrate 511B to complete the multilayer structure and to enable full encapsulation of the pattern(s).

In some configurations, the tape 50 can further comprise a number of additional layers. In such an event, it is preferred that the essentially flat, planar substrate layer 511A, in which the cavities 52 are formed, is made of substantially optically transparent material. The functional layer 511B is, in turn, configured as a contact layer, to establish a contact surface with topmost structures, such as layer 513. The layer 511B may thus be configured as an adhesive layer or a dry (solid) layer.

Areas of substrate material alternating with the cavities 52 form contact areas or contact points between the sublayers 511A, 511B, as well as between the optically functional layer 511 and the additional layers 512, 513. In certain conditions, the junction areas 53 form so called light passages, through which light is transmitted between the layers (511, 512 and 513). Light passages are formed when the substrate material 50A is an essentially light-transmitting carrier medium. The pattern 51 thus comprises a number of embedded cavities having contact points/light passages 53 in between.

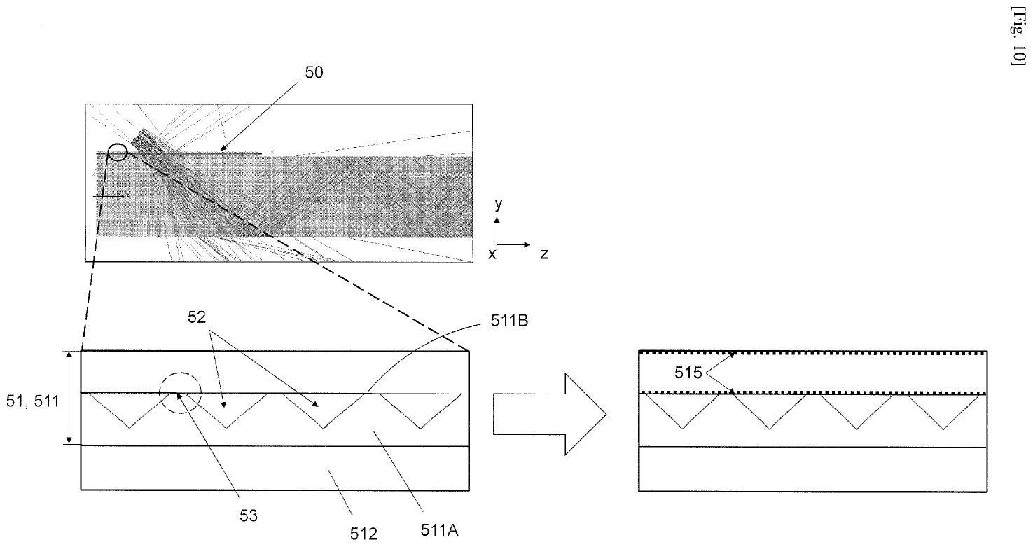

Manufacturing of the functional layer 511 is implemented by joining, preferably by lamination, two or more layers together, whereupon the entirely flat, planar layer 511B is placed against the patterned layer 511A. In some instances, two or more patterned layers can be laminated on top of each other to form a stack. In a basic layout, the open cavities formed in the flat, planar patterned layer become embedded at an entirely flat, planar interface formed between the layers. Flat contact areas 53 are formed during lamination (see also FIG. 10, dashed circle designated 53). An important benefit of the tape 50 is a possibility of utilizing a roll-to-roll production method in imprinting the pattern features and laminating all layers together such, that all functional layers are present in one product.

In basic configurations, the tape consists of at least one functional layer 511 formed with embedded cavity optics. To facilitate attachment, the tape further comprises at least one adhesive layer (see e.g. 512) on one- or both sides of said functional layer or a stack of functional layers.

The tape 50 may further comprise a number of additional functional layers, arranged at one or both sides of the optically functional layer 511 (or a stack of optically functional layers), such as a base layer designated on FIG. 3 as 512 and a topmost layer designated as 513. These layers render the tape with a number of additional functions.

By way of example, the base layer 512 may be configured as an adhesive layer to enable attachment, by adhesion, to the underlying lightguide medium. The adhesive layer 512 may be provided as an optically clear adhesive (OCA) or a liquid optically clear adhesive (LOCA). The adhesive layer may be provided on any surface of the tape or on both surfaces (top, bottom) of said tape. The tape 50 can thus be configured as a double-side adhesive tape for attaching different elements at either side of the tape.

The topmost/external layer 513 is a functional outer layer, which may be configured as any one of: an optically transparent layer, a non-transparent layer, a reflector layer, a low refractive index (Rᵢ) layer, and the like. Alternatively, the topmost layer 513 can be configured as an adhesive layer, similar to that of the base layer 512.

In some configurations, the optical incoupling tape is configured to perform a co-operative multi-function, wherein light directivity and wavelength management are executed, for example, by an integrated wavelength conversion layer, wherein monochromatic light, such as blue LED light, for example is partially or fully conversed.

The light incoupling tape can be provided with an additional functional layer (512, 513) configured as a wavelength conversion layer for partial or full conversion of monochromatic light, such as blue (LED) light, for example. The wavelength conversion layer can be arranged on a top- and/or bottom surfaces of the lightguide. In the latter event, the wavelength conversion layer can be arranged together with the adhesive layer and to form an optical connection with the lightguide. The layer with this additional conversion function can be utilized at the edge of the lightguide or on the planar area (light distribution area of said lightguide). Alternatively or additionally, the wavelength conversion layer can be utilized with the incoupling element 150.

By way of example, any one of the additional layers (e.g. 512, 513) can be configured as a black layer to absorb a portion of light passed through the light passages 53 forming the contact points at an interface between the layers. The tape with a black layer may be provided on a backside of the optical element for example. In another exemplary configuration, the additional layer(s) can be optically transparent layer for transmission of light through the contact points 53 at the interface between the layers (511, 512, 513). As discussed above, the contact points (light passages) are formed by the substrate areas 53. In similar manner, any of the additional layers can be configured as a reflector layer, wherein the material of said layer may be adopted for specular reflection, Lambertian reflection or provided as any other reflective non-transparent material. One special solution includes utilization of a low refractive index (Rᵢ) layer on the backside of the optically functional layer 511 or inside the layer 511, to make the contact points 53 causing the total internal reflection for the light incident thereon. Indicated solution typically enhances light intensity distribution/light harmonizing efficiency by about 6%-20% depending on the fill factor of said inter-connection points (areas 53) and their shape. Described configurations should be adjusted on case-by-case basis, taking into account position of the tape on the lightguide medium.

A primary optical function(s) of the tape 50 is to incouple optical radiation emitted from at least one emitter 30 and adjusting direction of optical radiation rays incident on the pattern(s). The tape is configured to adjust/modify direction of light received thereto such, that light incident on the pattern or patterns 51 is deflected to acquire a propagation path through a lightguide medium 20 via a series of total internal reflections. The pattern(s) 51 are therefore designed such that by virtue of said pattern(s), the tape is configured to mediate incoupled light propagation through the lightguide medium optionally towards the out-coupling area(s) 21 and optionally to control distribution of light propagating through the lightguide 20.

Light 31 received at the pattern is incoupled and deflected at the interface between each cavity 52 and the material of the substrate 50A surrounding the cavity. The pattern 51 and the features (cavities) thereof thus perform an optical function or a group of functions related to incoupling- and adjusting a direction of light received thereto. Incoupled and/or deflected light 32 acquires a propagation path through the lightguide medium, whereupon an angle of incidence at the interface between each cavity and the material of the substrate surrounding the cavity is/are larger than or equal to a critical angle of total internal reflection.

The pattern 51 is rendered optically functional by providing each individual cavity or a group of cavities in the pattern with a number of parameters, including, but not limited to: dimensions (size), shape, cross-sectional profile, orientation and position in the pattern, fill factor and periodicity.

A fill factor (FF) defined by a percent (%) ratio of the optical features 52 per a unit area is one of the key parameters in designing optical solutions. Fill factor defines a relative portion of the features 52 in the reference area (e.g. a pattern or any other reference area).

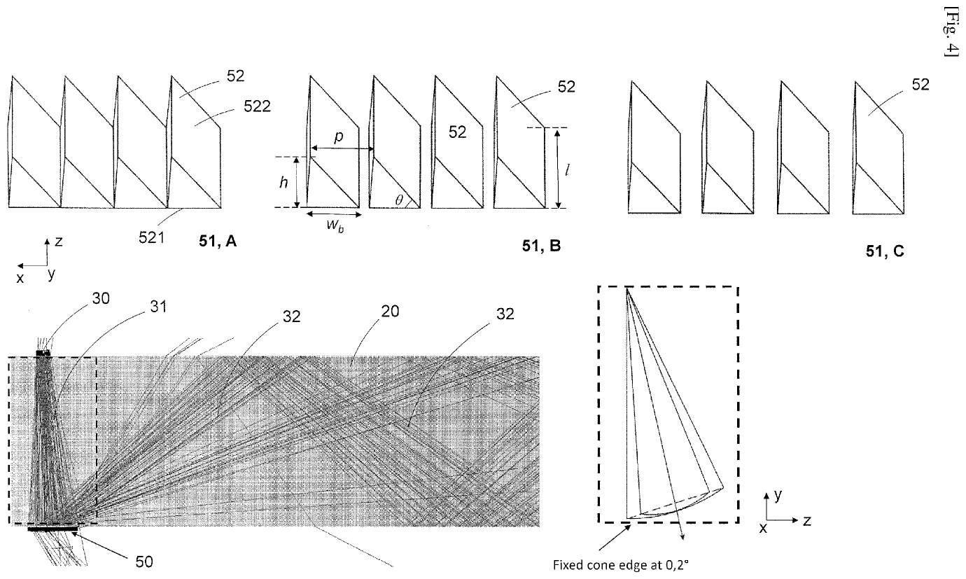

Each individual cavity in the pattern thus constitutes a profile having a number of optically functional surfaces. By way of example, optically functional surfaces 521, 522 (hereafter, a first optically functional surface and a second optically functional surface, accordingly) are schematically shown on FIG. 3 (see also FIG. 4). Each of said surfaces is established at the boundary interface between the cavity 52 and the surrounding substrate medium. One of the mentioned surfaces (hereby, the surface 521) may be provided as an essentially horizontal surface at an essentially in parallel with a longitudinal axis/plane of the lightguide and having light source(s) emitting light along essentially the same axis/plane, whereas the other one (hereby, the surface 522) may be provided as an inclined surface or a vertical surface, relative to the first surface. In fact, all surfaces in the cavity may be rendered optically functional.

The optically functional surface or surfaces is/are thus established by any surface or surfaces formed at the interface between each cavity and the material of the substrate surrounding the cavity.

In some configurations, each said optically functional surface or surfaces in each individual cavity in the pattern is/are established with any one of: a low refractive index reflector, a polarizer, a diffuser, an absorber, or any combination thereof. Thus, any one of the optically functional surfaces, e.g. 521, 522, can be provided with an appropriated coating, such as a low Rᵢ coating.

As mentioned above, one of the major functions of the optical incoupling tape 50 is incoupling- and deflection of light incident on the pattern at an angle of incidence larger than or equal to a critical angle of total internal reflection. An optical function performed by the tape is applied to light incident on the pattern (incident at the interface between the cavities and the surrounding medium. The incident light is incoupled and further deflected (re-directed) from its original propagation path by a certain angle) by means of (air)-cavity optics embedded inside of the tape.

In addition to regulating distribution of said TIR-mediated light propagation through the lightguide medium, the tape is configured to perform a number of additional optical functions, wherein a particular function or a combination of functions is determined by a number of factors, including cavity- and surrounding material related parameters, such as configurations of cavity profile(s) in the pattern and selection of materials (e.g. substrate material forming the optically functional layer 511, material of the additional layers 512, 513, cavity filling material).

In the tape 50, the at least one pattern is configured to perform an optical function related to incoupling light emitted from at least one emitter 30 and adjusting a direction of light received thereto, wherein said optical function includes, but is not limited to: a reflection function, an absorption function, a transmittal function, a collimation function, a refraction function, a diffraction function, a polarization function, and any combination thereof.

The cavities in the patterns perform the optical function or functions individually or collectively. Thus, the pattern may be configured such that all cavities in the pattern perform the same function (collective performance). In such an event, the pattern may comprise same (identical) cavities. Alternatively, each individual cavity 52 in the same pattern can be designed to establish an at least one optical function related to adjusting the direction of light received thereto. This is performed by adjusting (at design and manufacturing stage) cavity-related parameters, such as dimensions, shape, cross-sectional profile, orientation, position, periodicity, fill factor etc., as described above. The tape 50 can comprise a number of patterns, with each pattern comprising features/cavities differing from the features/cavities of any other pattern(s) in the tape by at least one parameter.

In the tape, that pattern or patterns are configured variable by a number of cavity-related parameters, wherein the number of cavity-related parameters comprises an individual parameter or any combination of parameters selected from the group consisting of: dimensions, shape, cross-sectional profile, orientation, position and periodicity.

Achieving the incoupling and deflection/(re)directing (deflection) function is assisted by provision of the light passage areas 53 between the cavities 52 (FIG. 3). Configuration of said light passages largely depends on configuration of the cavities and on the arrangement of said cavities in the pattern, however, e.g. light transmission property can be controlled and optimized by choice of substrate material.

Incoupled light with an optical redirecting function applied thereto (i.e. incoupled light rays whose direction is adjusted via interaction with the cavity pattern), also referred to as deflected and/or (re)directed light (32, FIG. 3) acquires a propagation path through a lightguide medium 20 via a series of total internal reflections.

The pattern(s) 51 in the tape can be further adjusted such that light is incident on said pattern(s) at an angle of incidence at the interface between each cavity in the pattern and the material of the substrate surrounding the cavity is/are larger than or equal to a critical angle of total internal reflection. By such an arrangement, direction of light received at the tape 50 and at the pattern(s) 51 is modified at the interface between each cavity in the pattern and the material of the substrate surrounding the cavity to acquire the propagation path through the lightguide medium, whereupon an angle of incidence at an interface between the lightguide medium and an ambient, and, optionally, an angle of incidence at the interface between each cavity and the material of the substrate surrounding the cavity is/are greater than or equal to a critical angle of total internal reflection.

By the incoupling tape 50, direction of incoupled light is further adjusted such that light arrives on a plane of the boundary (interface) between the lightguide medium and the ambient and, optionally, between each cavity and the substrate medium surrounding said cavity, at the angle of incidence greater than or equal to the critical angle of total internal reflection.

For clarity, the term “deflection” is used hereby primarily with regard to incoupled light rays whose direction is adjusted/modified at the tape 50 (i.e. modified to deviate from its original path, as emitted by the emitter), whereas the term “(re)directing” is applied both to light rays deflected (re-directed) at the tape and light rays that have acquired a propagation path through the lightguide via a series of TIRs after they have been deflected at the tape. Both deflection- and (re)direction functions aim at adjusting direction of optical radiation rays as a result of light interaction with interface/boundary materials (e.g. air-plastic). Interaction occurs, in turn, through a number of optical functionalities, such as reflection, refraction, etc.

Light is total internally reflected at the cavities 52 upon arriving on the pattern at a range of angles of incidence. The cavities 52 can thus be configured, in terms of the functional surfaces 521, 522, to receive and to further distribute light arriving at the pattern (at an angle of incidence equal to or greater than the critical angle relative to an interface created by any one of said optically functional surfaces).

When a ray of light moves through an optically transparent substrate 50A and strikes one of the internal cavity surfaces (521, 522) at a certain angle, the ray of light is either reflected from the surface back to the substrate or refracted into the cavity at the cavity-substrate interface. The condition according to which the light is reflected or refracted is determined by Snell's law, which gives the relationship between angles of incidence and refraction for a light ray incident on an interface between two media with different indices of refraction. Depending on the wavelength of light, for a sufficiently large incident angle (above the “critical angle”) no refraction occurs, and the energy of light is trapped within the substrate.

Critical angle is an incident angle of light relative to the surface normal, at which a phenomenon of the total internal reflection occurs. The angle of incidence becomes a critical angle (i.e. equal to the critical angle), when the angle of refraction constitutes 90 degrees relative to the surface normal. Typically, TIR occurs, when light passes from a medium with high(er) refractive index (Rᵢ) to a medium with low(er) Rᵢ, for example, from plastic (Rᵢ 1.4-1.6) or glass (Rᵢ 1.5) to the air (Rᵢ 1) or to any other media with essentially low refractive indices. For a light ray travelling from the high Rᵢ medium to the low Rᵢ medium, if the angle of incidence (at a glass-air interface, for example) is greater than the critical angle, then the medium boundary acts as a very good mirror and light will be reflected (back to the high Rᵢ medium, such as glass). When TIR occurs, there is no transmission of energy through the boundary. From the other hand, light incident at angle(s) less than the critical angle, will be partly refracted out of the high Rᵢ medium and partly reflected. The reflected vs refracted light ratio largely depends on the angles of incidence and the refraction indices of the media.

Critical angle varies with a substrate-air interface (e.g. plastic-air, glass-air, etc.). For example, for most plastics and glass critical angle constitutes about 42 degree. Thus, in an exemplary waveguide, light incident at a boundary between a light-transmitting medium, such as a PMMA sheet, and air at an angle of 45 degree (relative to the surface normal), will be probably reflected back to the lightguide medium, thereby, no light out-coupling will occur.

The same principle applies to light travelling, via a series of TIR, through the lightguide medium. We note, that TIR-mediated light propagation through the lightguide, may occur also outside the boundaries defined by the incoupling tape or tapes. TIR phenomenon is established by a lightguide design and/or choice of lightguide media.

Two- or three-dimensional pattern is established, typically with constant periodic pattern features or variable periodic pattern features. Periodicity is a necessary feature to control and deflect a plane wave in the lightguide medium and to redirect the incident light (i.e. light incident on the pattern) for preferred distribution. In additional case, aperiodic pattern features might be utilized for harmonizing non-uniform light flux and/or light distribution.

In each individual pattern, the cavities 52 can be established with discrete- or with at least partly continuous pattern features. Examples of discrete patterns include a dot, a pixel, and the like.

FIG. 4 illustrates the embedded cavity pattern 51 (A, B, C) with different fill factor. By way of example FIG. 4 shows (configuration A) that the cavity features 52 can be characterized by a number of parameters, such as length (l), width (w) and height (h) of the feature (on FIG. 4 bottom width w_{b} is shown). Additionally, the features 52 can be characterized with a length of a period (p) and a slope angle (θ).

Configurations A, B, C shown on FIG. 4 differ from one another only in terms of the fill factor. The features 52 indicate cavities, preferably, air cavities (material 50A surround the cavities 52 is not shown). Optically functional surfaces 521, 522 are indicated with regard to pattern 51 (A). The results of comparison are summarized in Tables 1-3 below.

TABLE 1
Pattern 51 (A), FIG. 4. 100% pattern fill factor (0 gap).
Optimized cone tilt, optimized blazed angle. Abbreviation
LGP stands for “lightguide plate”. Tilt angle and blazed
angle (also referred to as blaze angle) are shown on FIG. 4.

| | Collected light | Tilt | Blazed |
|---|---|---|---|
| Light Cone/° | in LGP/% | Angle/° | Angle/° |
| 0 | 82.9 | 0.2 | 41.1 |
| 10 | 77.5 | 4.8 | 41.0 |
| 20 | 71.0 | 12.6 | 38.8 |
| 30 | 62.3 | 14.8 | 38.6 |
| 40 | 54.5 | 21.8 | 36.8 |
| 50 | 50.2 | 26.4 | 34.4 |
| 60 | 54.2 | 43.0 | 25.0 |
| 70 | 50.4 | 43.3 | 24.5 |
| 80 | 47.6 | 44.9 | 24.7 |
| 90 | 43.8 | 44.4 | 24.6 |

TABLE 2
Pattern 51 (B), FIG. 4. 92% pattern fill factor (5 μm/micrometer
gap). Optimized cone tilt, optimized blazed angle.

| | Collected light | Tilt | Blazed |
|---|---|---|---|
| Light Cone/° | in LGP/% | Angle/° | Angle/° |
| 0 | 78.2 | 0.4 | 40.9 |
| 10 | 72.2 | 3.8 | 41.7 |
| 20 | 65.5 | 13.4 | 38.7 |
| 30 | 58.7 | 15.6 | 38.9 |
| 40 | 51.4 | 18.2 | 38.6 |
| 50 | 55.0 | 43.4 | 25.4 |
| 60 | 51.4 | 43.7 | 24.8 |
| 70 | 48.0 | 43.6 | 24.7 |
| 80 | 45.4 | 44.9 | 24.4 |
| 90 | 41.6 | 44.9 | 24.5 |

TABLE 3
Pattern 51 (C), FIG. 4. 86% pattern fill factor (10 μm/micrometer
gap). Optimized cone tilt, optimized blazed angle.

| | Collected light | Tilt | Blazed |
|---|---|---|---|
| Light Cone/° | in LGP/% | Angle/° | Angle/° |
| 0 | 72.9 | 0.0 | 41.3 |
| 10 | 65.0 | 0.0 | 43.7 |
| 20 | 54.7 | 0.2 | 44.8 |
| 30 | 47.4 | 1.7 | 44.3 |
| 40 | 50.0 | 30.6 | 32.0 |
| 50 | 52.9 | 44.0 | 24.6 |
| 60 | 49.3 | 44.1 | 24.6 |
| 70 | 45.5 | 44.1 | 24.6 |
| 80 | 42.4 | 44.1 | 24.6 |
| 90 | 39.9 | 44.8 | 24.6 |

The pattern(s) A, B, C are provided in the incoupling tape 50 attached to the back side of the lightguide (FIG. 4). The emitter device 30 (with a collimator) is installed at the other side of the lightguide (top side). The arrangement is thus the same as schematically depicted on FIG. 1B. A dashed box (FIG. 4) shows a light cone (collimated and tilted light) with a fixed cone edge at 0.2 degree)(°.

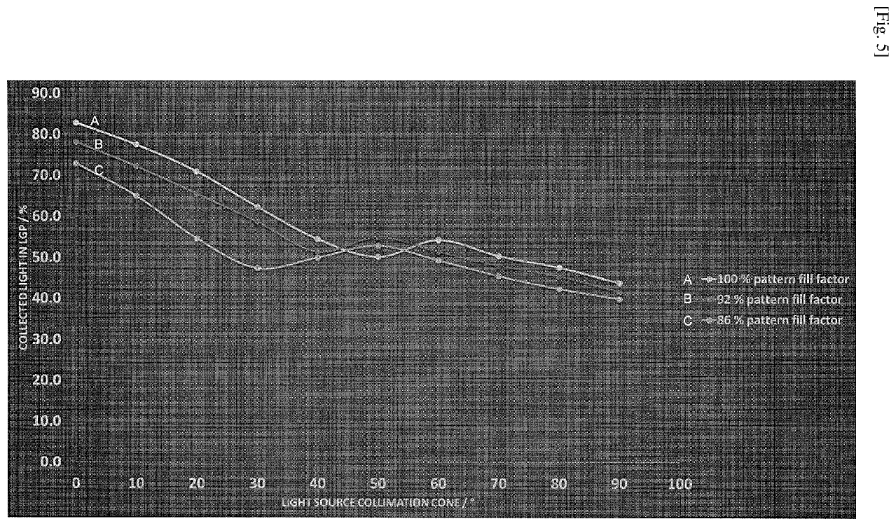

FIG. 5 is a graph illustrating an amount of incoupled light (%, y-axis) relative to light source collimation (degree, light cone; x-axis) and position of the patterns 51 (A, B, C) with different fill factor (as shown on FIG. 4). The tape 50 comprising mentioned patterns 51 (A, B, C) is positioned on the back side of the lightguide as shown on FIG. 4 (side opposite to the light source 30).

FIG. 6 describes an arrangement similar to that illustrated on FIG. 4, but having the cavity features 52 in the embedded pattern supplied with a low refractive index (low Rᵢ) material. The low Rᵢ material can be provided as a filling material for the cavities and/or as coating material for coating said cavities. Pattern fill factor is 100%.

The low refractive index material is a material typically having the refractive index within a range of 1.10-1.41. Refractive index of the low Rᵢ material is typically below 1.5; preferably, below 1.4. The refractive index of the material referred to on FIG. 6 is 1.18 (in present case, the low Rᵢ material is the material that fills the cavities 52). In such an event, the embedded pattern can be rendered with an optical filter functionality, defined as a capability of changing the spectral intensity distribution or the state of polarization of electromagnetic radiation incident thereupon. The filter may be involved in performing a variety of optical functions, such as transmission, reflection, absorption, refraction, interference, diffraction, scattering and polarization.

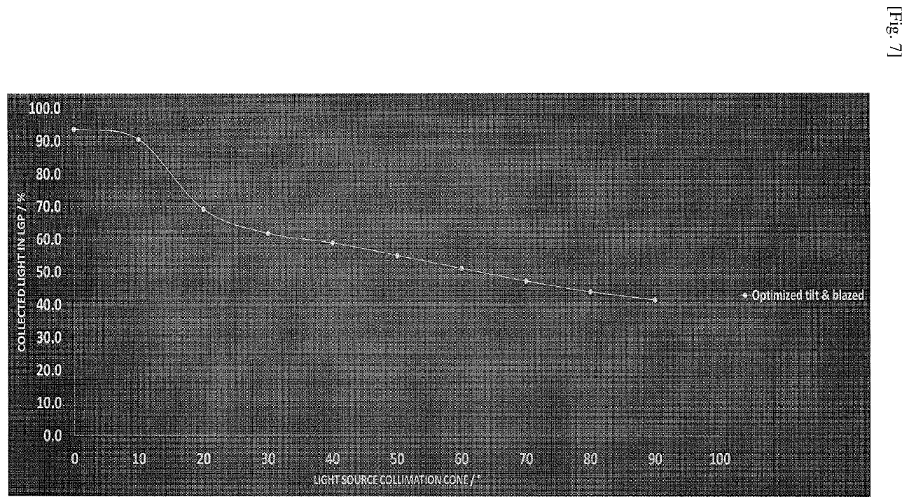

FIG. 7 is a graph illustrating an amount of incoupled light (%, y-axis) relative to light source collimation (degree, light cone; x-axis) and position of the pattern having cavities supplied with low Rᵢ material, as described with reference to FIG. 6.

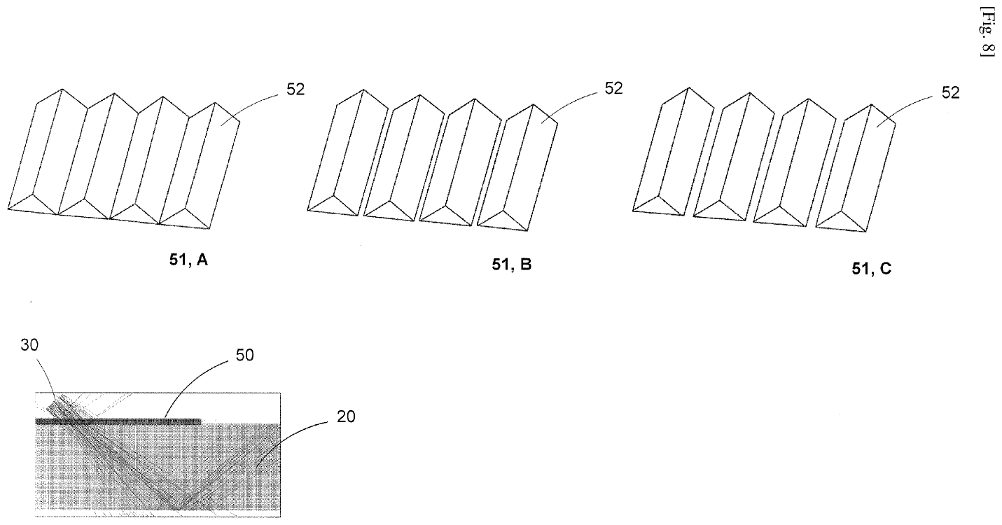

FIG. 8 describes an arrangement schematically depicted on FIG. 1A, wherein the incoupling tape 50 is provided on the top side of the lightguide 20 and wherein light (from the emitter 30) is incident directly on said tape. The embedded cavity pattern 51 comprises a plurality of prismatic cavity features 52 (material 50A surround the cavities 52 is not shown). Configurations A, B, C shown on FIG. 8 differ from one another only in terms of the fill factor. Emitted light is collimated with a collimator (lens). The results of comparison are summarized in Tables 4-6 below.

TABLE 4
Pattern 51 (A), FIG. 8. 100% pattern fill factor (0 gap).
Optimized cone tilt, optimized blazed angle. Abbreviation
LGP stands for “lightguide plate”. Prism angle 1 refers
to a prism angle for a left side surface and Prism angle
2 refers to a prism angle for a right side surface (FIG. 8).

| | Collected light | Tilt | Prism | Prism |
|---|---|---|---|---|
| Light Cone/° | in LGP/% | Angle/° | angle 1/° | angle 2/° |
| 0 | 87.9 | 41.7 | 48.0 | 44.9 |
| 10 | 71.2 | 41.7 | 48.0 | 44.9 |
| 20 | 58.2 | 41.7 | 48.0 | 44.9 |
| 30 | 52.8 | 41.7 | 48.0 | 44.9 |
| 40 | 49.6 | 41.7 | 48.0 | 44.9 |
| 50 | 46.7 | 41.7 | 48.0 | 44.9 |
| 60 | 43.9 | 41.7 | 48.0 | 44.9 |
| 70 | 40.8 | 41.7 | 48.0 | 44.9 |
| 80 | 37.3 | 41.7 | 48.0 | 44.9 |
| 90 | 35.1 | 41.7 | 48.0 | 44.9 |

TABLE 5
Pattern 51 (B), FIG. 8. 92% pattern fill factor (5 μm/micrometer
gap). Optimized cone tilt, optimized blazed angle.

| | Collected light | Tilt | Prism | Prism |
|---|---|---|---|---|
| Light Cone/° | in LGP/% | Angle/° | angle 1/° | angle 2/° |
| 0 | 81.0 | 44.7 | 45.7 | 55.7 |
| 10 | 79.5 | 44.7 | 45.7 | 55.7 |
| 20 | 77.0 | 44.7 | 45.7 | 55.7 |
| 30 | 70.2 | 44.7 | 45.7 | 55.7 |
| 40 | 61.8 | 44.7 | 45.7 | 55.7 |
| 50 | 55.1 | 44.7 | 45.7 | 55.7 |
| 60 | 49.4 | 44.7 | 45.7 | 55.7 |
| 70 | 44.5 | 44.7 | 45.7 | 55.7 |
| 80 | 40.1 | 44.7 | 45.7 | 55.7 |
| 90 | 37.2 | 44.7 | 45.7 | 55.7 |

TABLE 6
Pattern 51 (C), FIG. 8. 86% pattern fill factor (10 μm/micrometer
gap). Optimized cone tilt, optimized blazed angle.

| | Collected light | Tilt | Prism | Prism |
|---|---|---|---|---|
| Light Cone/° | in LGP/% | Angle/° | angle 1/° | angle 2/° |
| 0 | 75.3 | 45.2 | 50.6 | 52.5 |
| 10 | 74.0 | 45.2 | 50.6 | 52.5 |
| 20 | 72.4 | 45.2 | 50.6 | 52.5 |
| 30 | 63.8 | 45.2 | 50.6 | 52.5 |
| 40 | 56.4 | 45.2 | 50.6 | 52.5 |
| 50 | 49.5 | 45.2 | 50.6 | 52.5 |
| 60 | 44.4 | 45.2 | 50.6 | 52.5 |
| 70 | 40.5 | 45.2 | 50.6 | 52.5 |
| 80 | 36.6 | 45.2 | 50.6 | 52.5 |
| 90 | 33.3 | 45.2 | 50.6 | 52.5 |

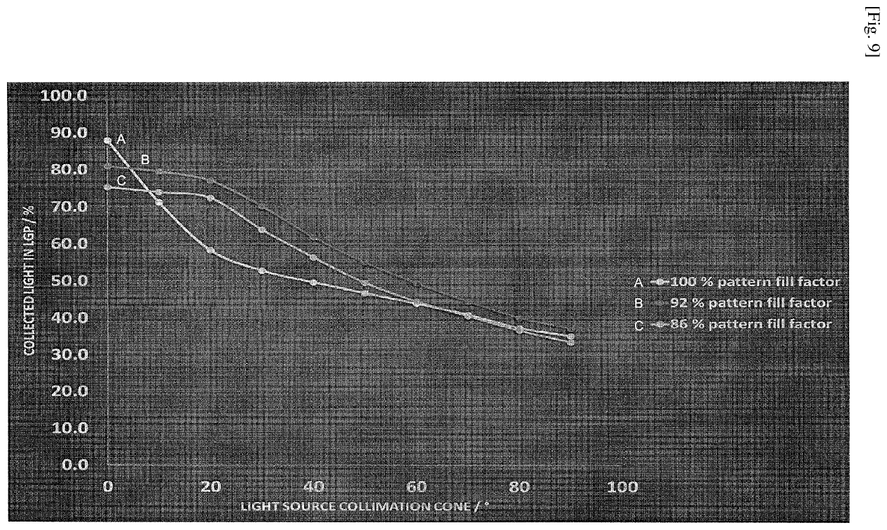

FIG. 9 is a graph illustrating an amount of incoupled light (%, y-axis) relative to light source collimation (degree, light cone; x-axis) and position of the patterns 51 (A, B, C) with different fill factor (as shown on FIG. 8). The tape 50 comprising mentioned patterns 51 (A, B, C) is positioned on the top side of the lightguide as shown on FIG. 8 (same side as the light source 30).

FIG. 10 is a cross-sectional view of the optical incoupling tape 50 with the embedded air-cavity pattern 51. The tape is attached on the top surface of the lightguide element 20 (lightguide plate, LGP). Collimated light from the emitter 30 is received directly on the tape 50. An enlarged area shown on FIG. 10 represents the tape 50 with the embedded pattern 51 (formed by layers 511A, 511B, as discussed above) and an underlying layer (512) of optically clear adhesive. The cavities 52 are filled with air. Contact areas are formed 52 to enable light passages through the layers. Fill factor is 86%.

The setup shown on FIG. 10 enables achieving 73-75% incoupling efficiency with a collimation cone of about 10° at a tilt angle of 50° (with Fresnel reflection).

The setup can be further modified by providing at least one layer 515 inside the tape 50 and the optically functional layer 511. The internal layer(s) 515 can be configured as antireflective (AR) layers, for example. In present example (FIG. 10, right) the flat substrate layer 511B has been pre-coated with the AR coating (515) prior to joining the flat layer 511B to the patterned layer 511A. In similar manner, the patterned layer 511A can be pre-coated with the coating 515. The setup including the internal AR coating enables achieving incoupling efficiency up to about 83%.

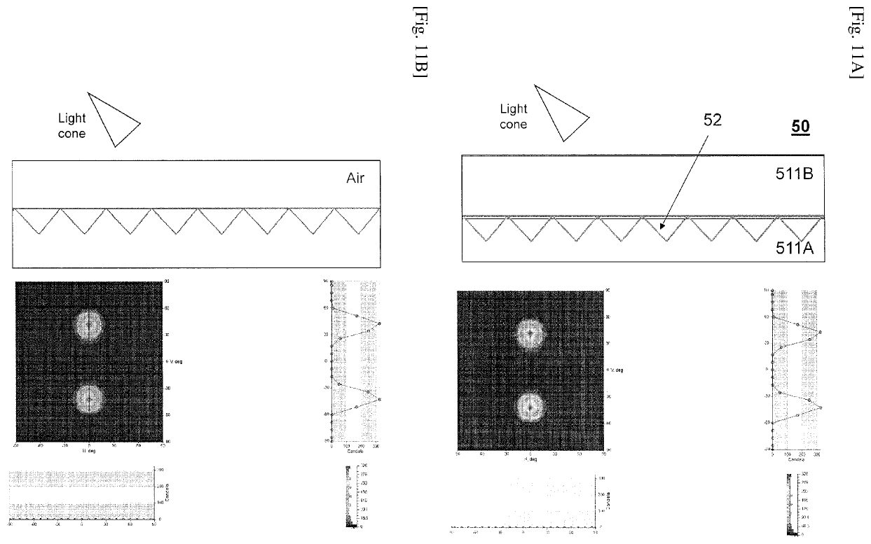

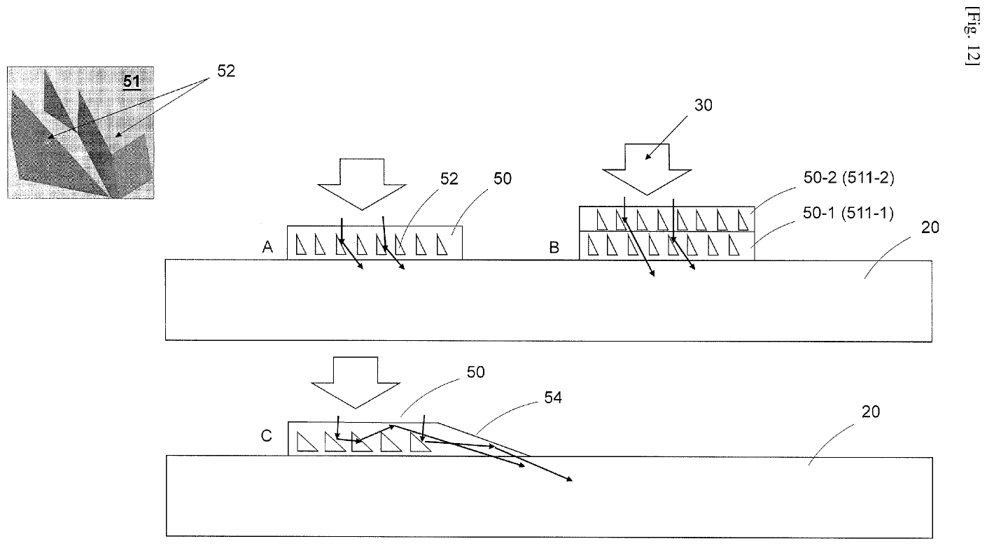

FIGS. 11A and 11B illustrate the optical incoupling tape 50 on the top surface of the lightguide element 20 with the collimated light source 30.

FIG. 11A is a cross-section view of the tape 50 with fully embedded air-cavity pattern comprising prismatic cavity features 52 with optimized shape. Other setup parameters include: LED collimation (light cone) about 10°; LED light tilt 50°; no Fresnel reflections; Intensity distribution inside the lightguide element is discretized, which is typically observable in a cross-section of the lightguide. The tape allows for achieving incoupling efficiency of up to 87%.

FIG. 11B is a cross-section view of an exemplary tape 50 with the air-cavity pattern comprising prismatic cavity features with optimized shape. Other setup parameters are the same as for FIG. 11A. The tape allows for achieving incoupling efficiency of up to 94%.

In the pattern, the cavities can be further configured and arranged such, as to form a substantially variable (or segmental) periodic pattern, wherein each local pattern design has features substantially variable within said pattern. Thus, in some configurations, the tape 50 comprises a number of patterns arranged in periodic segments, wherein each segment has a predefined area and a length of a period (not shown). These local patterns can be rendered variable in terms of modifying pattern- and/or cavity-related parameters, to manage light incident thereto at a predetermined angle or a range of angles. The cavity profiles can be configured variable in terms of a number of parameters selected from any one of: dimensions, shape, cross-sectional profile, orientation and position in the pattern.

In the tape, the cavities 52 are thus established with two-dimensional- or three-dimensional pattern features having cross-sectional profiles selected from the group consisting of: linear, rectangular, triangular, blazed, slanted, trapezoid, curved, wave-shaped and sinusoidal profiles.

Furthermore, in terms of pattern(s) configuration and arrangement, the tape 50 is designed and optimized for a certain lightguide thickness and other lightguide-specific parameters.

An example of a three-dimensional, diamond blazed pattern design 51 with air cavities 52 is shown on FIG. 12 (box in the left upper corner). This pattern may be configured as a hybrid optical pattern. FIG. 12 further shows a number of embodiments for the tape 50 and its provision on the lightguide element 20. Thus, configuration A shows the tape 50 with a single pattern layer.

Configuration B shows the tape implemented as a dual- or a multilayer solution. In configuration B, the functional layer 511 and the tape 50 can be implemented with a number of embedded patterns arranged in stacked configuration. Configuration includes joining two or more patterned layers (511A), optionally, optically functional layers (511), together to form a multilayer solution in a single tape. In some configurations, the patterned layers 511A may optionally alternate with the flat substrate layers 511B. Additionally or alternatively, two or more tapes 50 (50-1, 50-2) can be applied on the top of each other to form a dual-layer or a multilayer tape configuration, accordingly.

In a multilayer configuration, the tape may be formed with a stack comprising two or more patterned layers (referenced as 511A) positioned on the top of each other. Flat, planar interface between the layers may thus be established by virtue of said patterned layers 511A alone (requires that the layer has a pattern established in one of its surfaces, the other surface remaining entirely flat). The topmost patterned layer may thus be provided with the entirely flat substrate 511B to complete the multilayer structure and to enable full encapsulation of the pattern(s).

The stack may thus be implemented with any one of: the patterned layer(s) (511A) optionally alternating with entirely flat substrate layers (511B); the optically functional layers (511); and the tapes 50. The patterns located at different levels in the stack may be configured to perform same of different optical function related to incoupling- and adjusting direction of light received thereto, wherein said optical function is selected from a group consisting of: an incoupling function, a reflection function, a redirecting function, a deflection function, an absorption function, a transmittal function, a collimation function, a refraction function, a diffraction function, a diffusion function, a polarization function, and any combination thereof.

In configuration C, the tape 50 comprises a shaped structure 54 at least one end thereof. Arrangement of the shaped structure at both ends of the tape can be conceived in similar manner (not shown). The shaped structure is defined with at least a portion of the exterior surface of the tape laid essentially opposite to a lightguide attachment surface. Configuration of said shaped structure may be any one of tapered, inclined (sloped) or convex relative to the longitudinal plane of the planar lightguide. The tape 50 with an optical wedge 54 formed hereby can be configured (in terms of optical patterns) for hybrid coupling.

The tape 50 can be provided in the form of a roll, as being produced by roll-to-roll lamination processes.

In an aspect, the optical apparatus (unit) 150 is provided, said unit comprising the tape 50 and at least one emitter 30 for emitting optical radiation incident on the tape 50 (as described with reference to FIG. 1C). The unit 150 thus provides a compact solution, in which a light source(s) is integrated with optics. The latter may be configured as embedded (air)-cavity optics or relief (open cavity) optics.

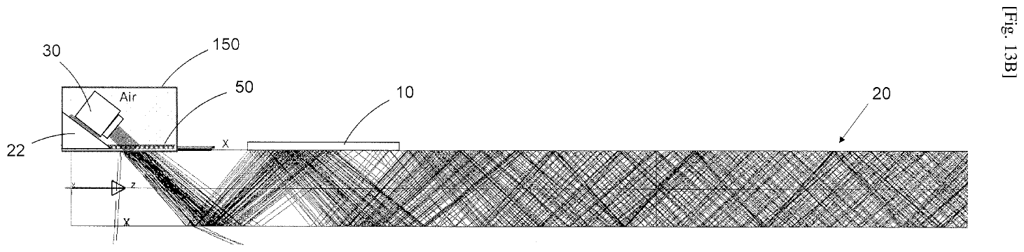

FIGS. 13A and 13B are illustrative of utilization of the optical incoupling tape 50 and the unit 150 utilizing the same in combination with a light harmonizer tape 10. The harmonizer tape 10 (also referred to as a deflection tape) may be attached on the lightguide within a predetermined area subsequent to the incoupling area (the latter having the incoupling tape 50 or the unit 150 attached/mounted thereto). The harmonizer tape may thus cover some region or regions within the light distribution area of said lightguide, viz. the area between the incoupling- and outcoupling regions. The tape 10 may be arranged along the entire light distribution area of the lightguide.

The harmonizer tape 10 is implemented based on similar cavity optics solutions as described with regard to the optical incoupling tape 50 hereinabove. While the primary function of the incoupling tape 50 is incoupling of emitted light rays and adjusting direction of incoupled light to mediate light propagation through the lightguide; the primary function of the harmonizer tape 10 is deflection and redirecting of light incident on said tape to control distribution of light propagating through the lightguide. Optical functions of tapes 50, 10 are adjustable in terms of cavity-related parameters and tape-related parameters (e.g. substrate materials, overall implementation, etc.), as described herein above. Hence, provision of the harmonizer tape 10 enables improved internal light distribution uniformity in the lightguide (mediated by enhanced TIR functionality enabled by the harmonizer tape 10).

In another aspect, a method for manufacturing the optical incoupling tape 50 is provided, said method comprises: manufacturing a patterned master tool for said at least one pattern by a suitable fabrication method; transferring the pattern onto the substrate to generate a patterned substrate; and generating an embedded cavity pattern or patterns by applying, onto said patterned substrate, an additional flat, planar substrate layer, such that internal cavities are formed at a fully flat, planar interface between the substrate layers.

The pattern can be fabricated by any suitable method, including, but not limited to: lithographic, three-dimensional printing, micro machining, laser engraving, or any combination thereof. Other appropriate methods may be utilized.

It is preferred that the embedded cavity pattern or patterns is implemented by a roll-to-roll lamination methods, wherein sublayers 511A, 511B are laminated against one another to form the optically functional layer 111.

The additional substrate layer (511B) can be applied onto the patterned substrate layer (511A) by a lamination method selection from any one of: a roll-to-roll lamination, a roll-to-sheet lamination or a sheet-to-sheet lamination.

Once fabricated pattern is advantageously further replicated by any suitable method, such imprinting, extrusion replication or three-dimensional printing. Any other appropriate method may be utilized.

Typical production line is adopted to perform the following processes: a) pattern fabrication and replication; b) cavity lamination; c) preparation of other/additional layer(s) and lamination thereof; and d) final film cutting. The production line can be further adopted for manufacturing narrow- or wide tape products.

A sheet or a roll of the optical incoupling tape produced during steps a-c can be transferred for cutting elsewhere.

The invention further pertains to provision of a lightguide 20 comprising an optically transparent medium configured to establish a path for light propagation through the lightguide, and the optical incoupling tape 50, implemented according to the embodiments described hereinabove, wherein the optical incoupling tape is attached onto at least one planar surface of said lightguide. In some configurations, the optical incoupling tape is attached to the lightguide by adhesion.

A use of said lightguide in illumination and/or indication is further provided. The lightguide can be used for the illumination and indication related purposes including, but not limited to: of decorative illumination, light shields and masks, public and general illumination, including window, facade and roof illumination, signage-, signboard-, poster- and/or an advertisement board illumination and indication, and in solar applications. It is clear to a person skilled in the art that with the advancement of technology the basic ideas of the present invention are intended to cover various modifications thereof. The invention and its embodiments are thus not limited to the examples described above; instead they may generally vary within the scope of the appended claims.

### REFERENCES

1. Carlos Angulo Barrios and Victor Canalejas-Tejero, “Light coupling in a Scotch tape waveguide via an integrated metal diffraction grating,” Opt. Lett. 41, 301-304 (2016).
2. Bernard C. Kress, “Optical waveguide combiners for AR headsets: features and limitations”, Proc. SPIE 11062, Digital Optical Technologies 2019, 110620J (16 Jul. 2019).
3. Moon et al, “Microstructured void gratings for outcoupling deep-trap guided modes,” Opt. Express 26, A450-A461 (2018).

1. An optical incoupling tape for a lightguide, comprising:
a substrate, and
at least one pattern formed with a number of periodic pattern features embedded in a substrate material and configured as optically functional embedded cavities filled with a material having a refractive index different from the refractive index of the material of the substrate surrounding the cavity,
wherein the pattern is configured to incouple light incident thereto and to adjust direction of the incoupled light such, that the incoupled light acquires a propagation path through a lightguide medium via a series of total internal reflections, and
wherein said optical incoupling tape is attachable onto at least one planar surface of the lightguide, whereby an optical contact for light transmission between the tape and a lightguide medium is formed.

2. The optical incoupling tape of claim 1, wherein the incoupled light is redirected at an interface between each said cavity and the material of the substrate surrounding the cavity to acquire the propagation path through the lightguide medium, whereupon an angle of incidence at an interface between the lightguide medium and an ambient, and, optionally, an angle of incidence at the interface between each cavity and the material of the substrate surrounding the cavity is/are larger than or equal to a critical angle of total internal reflection.

3. The optical incoupling tape of claim 1, wherein the at least one pattern is configured to perform an optical function related to incoupling- and adjusting direction of light received thereto, wherein said optical function is selected from a group consisting of: a reflection function, an absorption function, a transmittal function, a collimation function, a refraction function, a diffraction function, a polarization function, and any combination thereof.

4. The optical incoupling tape of claim 1, wherein the pattern is rendered optically functional by providing a cavity or a group of cavities in the pattern with a number of parameters, wherein the number of parameters comprises any combination of parameters selected from the group consisting of: dimensions, shape, cross-sectional profile, orientation, periodicity, and fill factor.

5. The optical incoupling tape of claim 1, wherein each individual cavity in the pattern has a number of optically functional surfaces.

6. The optical incoupling tape of claim 1, wherein the optically functional surface or surfaces is/are established by any surface or surfaces formed at the interface between each cavity and the material of the substrate surrounding the cavity.

7. The optical incoupling tape of claim 1, wherein the optically functional surface or surfaces in each individual cavity in the pattern is/are established with any one of a low refractive index reflector, a polarizer, a diffuser, an absorber, or any combination thereof.

8. The optical incoupling tape of claim 1, wherein the cavities are configured and arranged in the pattern such, as to form a substantially variable periodic pattern.

9. The optical incoupling tape of claim 1, wherein the cavities are configured and arranged in the pattern such, as to form a substantially constant periodic pattern.

10. The optical incoupling tape of claim 1, wherein in the pattern the cavities are established with discrete or at least partly continuous pattern features.

11. The optical incoupling tape of claim 1, comprising a number of patterns arranged in periodic segments, each segment having a predefined area and a length of a period.

12. The optical incoupling tape of claim 1, wherein the patterns are configured variable by a number of cavity-related parameters, wherein the number of cavity-related parameters comprises an individual parameter or any combination of parameters selected from the group consisting of: dimensions, shape, cross-sectional profile, orientation, position, periodicity, and fill factor.

13. The optical incoupling tape of claim 1, wherein the cavities are established with two-dimensional- or three-dimensional pattern features having cross-sectional profiles selected from the group consisting of: linear, rectangular, triangular, blazed, slanted, trapezoid, curved, wave-shaped and sinusoidal profiles.

14. The optical incoupling tape of claim 1, wherein the cavities are filled with a gaseous material, such as air.

15. The optical incoupling tape of claim 1, configured attachable onto a planar surface or planar surfaces of the lightguide by adhesion.

16. The optical incoupling tape of claim 1, wherein the pattern or patterns comprise(s) cavities formed in the substrate provided as an essentially flat, planar substrate layer.

17. The optical incoupling tape of claim 1, wherein the essentially flat, planar substrate layer, in which the cavities are formed, is made of substantially optically transparent material.

18. The optical incoupling tape of claim 1, wherein the pattern or patterns comprise(s) cavities formed at an interface with an additional flat, planar substrate layer, provided as an optically transparent layer, a reflector layer, and/or a coloured layer.

19. The optical incoupling tape of claim 1, comprising a number of embedded patterns arranged in a stacked configuration.

20. The optical incoupling tape of claim 1, comprising a wedge structure.

21. The optical incoupling tape of claim 1, further comprising a wavelength conversion layer.

22. A method for manufacturing an optical incoupling tape comprising at least one pattern formed with a number of periodic cavity features embedded in a substrate material, said method comprises:
manufacturing a patterned master tool for said at least one pattern by a fabrication method selected from any one of: lithographic, three-dimensional printing, micro-machining, laser engraving, or any combination thereof;
transferring the pattern onto the substrate to generate a patterned substrate; and
generating an embedded cavity pattern or patterns by applying onto said patterned substrate an additional substrate layer or a cover layer,
wherein the embedded cavity pattern(s) comprise(s) cavities configured as optically functional cavities filled with a material having a refractive index different from the refractive index of the material of the substrate surrounding the cavity, and
wherein said embedded cavity pattern is configured to incouple light incident thereto and to adjust direction of the incoupled light such, that the incoupled light acquires a propagation path through a lightguide medium via a series of total internal reflections.

23. The method of claim 22, wherein the additional substrate layer is applied onto the patterned substrate layer by a lamination method selected from any one of: a roll-to-roll lamination, a roll-to-sheet lamination or a sheet-to-sheet lamination.

24. The method of claim 22, further comprising replication of a fabricated pattern, wherein pattern replication method is selected from any one of imprinting, extrusion replication or three-dimensional printing.

25. A lightguide, comprising an optically transparent medium configured to establish a path for light propagation through the lightguide, and an optical incoupling tape, as defined in claim 1, said optical incoupling tape being attached onto at least one planar surface of said lightguide.

26. The lightguide of claim 25, comprising the optical incoupling tape attached thereto by adhesion.

27. Use of a lightguide, as defined in claim 25, in illumination and/or indication.

28. A roll of an optical incoupling tape, in which the optical incoupling tape is implemented in accordance to what is defined in claim 1.

29. An optical unit, comprising an optical incoupling tape with an adhesion layer for a lightguide attachment and at least one emitter device, wherein the optical incoupling tape is configured as defined in claim 1.

30. The optical unit of claim 29, wherein the at least one emitter device is selected from a group consisting of: a Light Emitting Diode (LED), an Organic Light Emitting Diode (OLED), a laser diode, a LED bar, an OLED strip, a microchip LED strip, and a cold cathode tube.

31. The optical incoupling tape of claim 29, comprising at least one light emitter device configured for emitting monochromic light, and the optical incoupling tape that comprises the wavelength conversion layer.
